(19) United States
(12) Patent Application Publication
(10) Pub. No.: US 2024/0184945 A1
(43) Pub. Date: Jun. 6, 2024

(54) PIPELINE CORROSION ASSESSMENT

(71) Applicant: SAUDI ARABIAN OIL COMPANY, Dhahran (SA)

(72) Inventors: Faisal Mohammed AL-ABBAS, Dammam (SA); Omar Abdullah AL-SAIF, Safwa (SA); Christian Canto MAYA, Dhahran (SA); Lay Seong TEH, Dhahran (SA); Mohammed A. AL-HURAIFI, Al-Qatif (SA); Meshal K. AL-ARFAJ, Dhahran (SA); Yousef A. AL-ROWAISHED, Abqaiq (SA)

(73) Assignee: SAUDI ARABIAN OIL COMPANY, Dhahran (SA)

(21) Appl. No.: 18/060,675

(22) Filed: Dec. 1, 2022

(51) Int. Cl. G06F 30/20

(52) U.S. Cl. CPC G06F 30/20; G06F 2113/08

(57) ABSTRACT

The present disclosure relates to a method that includes: generating a corrosion risk profile for a first pipe region of at least one pipe region of a hydrocarbon pipeline configured to carry a hydrocarbon fluid, wherein generating the corrosion risk profile comprises: simulating hydraulic flow within a first sampling segment within the first pipe region using a hydraulic model; simulating water wetting within the first sampling segment using a water wetting model; interpolating between the first sampling segment and a second sampling segment using a nodal model; simulating corrosion for at least one first node between the first sampling segment and the second sampling segment using a corrosion model; and generating the corrosion risk profile for the first pipe region; analyzing the corrosion risk profile in order to calculate a corrosion risk score for the first pipe region.

### FIELD OF THE DISCLOSURE

The present disclosure relates generally to maintenance of hydrocarbon pipelines and, more particularly, to corrosion mitigation.

### BACKGROUND OF THE DISCLOSURE

Pipelines provide a cost effective hydrocarbon transport. Pipelines are often made from steel, which makes these pipelines susceptible to corrosion. The corrosion may occur when water or other corrosive materials contacts the pipeline, which may occur on the outer surface of the pipeline or on the inner surface of the pipeline due to corrosive materials present in the hydrocarbon being transported. Many methods are employed to prevent corrosion including cathodic protection and surface treatments including anodization and coatings.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A nonlimiting method of the present disclosure comprises generating a corrosion risk profile for a first pipe region of at least one pipe region of a hydrocarbon pipeline configured to carry a hydrocarbon fluid, wherein generating the corrosion risk profile comprises: simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property; simulating water wetting within the first sampling segment using a water wetting model, wherein a water wetting model input comprises the per sampling segment hydraulic property from the hydraulic model, and wherein a water wetting model output comprises a wetting condition indicator; interpolating between the first sampling segment and a second sampling segment using a nodal model, wherein a nodal model input comprises the wetting condition indicator from the water wetting model, and wherein a nodal model output comprises a per node hydraulic property; simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and generating the corrosion risk profile for the first pipe region based on a corrosion likelihood criteria, the corrosion properties, the per sampling segment hydraulic property, and the per node hydraulic property; analyzing the corrosion risk profile in order to calculate a corrosion risk score for the first pipe region.

The present disclosure includes a nonlimiting machine-readable storage medium having stored thereon a computer program for performing the steps of: generating a corrosion risk profile for a first pipe region of at least one pipe region of a hydrocarbon pipeline configured to carry a hydrocarbon fluid, wherein generating the corrosion risk profile comprises: simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property; simulating water wetting within the first sampling segment using a water wetting model, wherein a water wetting model input comprises the per sampling segment hydraulic property from the hydraulic model, and wherein a water wetting model output comprises a wetting condition indicator; interpolating between the first sampling segment and a second sampling segment using a nodal model, wherein a nodal model input comprises the wetting condition indicator from the water wetting model, and wherein a nodal model output comprises a per node hydraulic property; simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and generating the corrosion risk profile for the first pipe region based on a corrosion likelihood criteria, the corrosion properties, the per sampling segment hydraulic property, and the per node hydraulic property; analyzing the corrosion risk profile in order to calculate a corrosion risk score for the first pipe region.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates a diagram of a method for assessing and mitigating corrosion in accordance with the present disclosure.

FIG. 2 illustrates levels of hierarchy for a nonlimiting example pipeline system of the present disclosure.

FIG. 3 illustrates a diagram of a physical modeling sub-method including a physical corrosion model in accordance with the present disclosure.

FIGS. 4A and 4B illustrate nonlimiting example graphical user interfaces showing corrosion risk scores.

FIG. 5 illustrates a nonlimiting example computer system that can be employed to execute one or more embodiments of the present disclosure.

### DETAILED DESCRIPTION

Embodiments of the present disclosure will now be described in detail with reference to the accompanying Figures. Like elements in the various Figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to maintenance of hydrocarbon pipelines and, more particularly, to corrosion mitigation.

Assessment and mitigation of corrosion remains a great cost to operators of hydrocarbon pipelines, particularly in non-scrapable pipelines. A “non-scrapable pipeline” (i.e., a non-piggable pipeline), as used herein, refers to a pipeline that cannot be inspected or cleaned through the use of a “pig” or remote controlled robotic device in the pipeline. Pipelines that are non-scrapable may be more likely to require costly maintenance or replacement due to the reduced monitoring capability. The present disclosure provides a method and system for assessing the corrosion risk of a pipe region within a hydrocarbon pipeline, including within a non-scrapable pipeline.

“Hydrocarbon pipeline,” or simply “pipeline” or “pipe” as used herein refers to a pipeline or portion of a pipeline capable of carrying a hydrocarbon (also referred to as “hydrocarbon fluid”) including, but not limited to, dry gas, wet gas, liquid petroleum, oil, methane, ethane, propane, the like, or any combination thereof. It should be noted that the hydrocarbon fluid may comprise additional species, including, but not limited to, water, dissolved solids, the like, or any combination thereof, in any amount.

“Corrosion” as used herein refers to deterioration of a material as a result of contact with a degradative species in its surroundings. In the case of the present disclosure, corrosion may include, but is not limited to, water wetting, sweet corrosion (e.g., CO₂ corrosion), sour corrosion (e.g., H₂S corrosion), microbial induced corrosion (MIC), top of the line corrosion (TLC), scale formation, solid accumulation, or any other corrosion method or type known in the art, as well as any combination thereof.

Existing methods of modeling corrosion risk involve disparate systems that may individually model hydraulics, fluid flow, and individual pipe corrosion, and may only utilize limited or no historical data concerning pipelines when assessing risk. Additionally, existing systems may be limited to a singular pipe region at one time, necessitating costly manual calculation and limiting the availability of corrosion risk data.

The present disclosure provides integrated methods and systems for assessing and mitigating corrosion utilizing a combination of models and systems to predict corrosion within an entire network of pipelines. The present disclosure may allow for increased accuracy of corrosion risk predictions due to the combination of multiple models and data sources including historical data as part of corrosion risk modeling and assessment. Additionally, the present disclosure may allow for increased precision of corrosion risk analysis enabled by dynamic segmentation of pipelines, enabling detailed viewing of risk conditions for many regions within a pipeline network. This risk analysis may also be able to be carried out with greater frequency than a conventional system, as a result of the integrated approach capable of analyzing an entire pipeline network or multiple portions of a pipeline network at once.

Furthermore, the present disclosure also provides corrosion risk assessment and mitigation systems and methods that can account for a wide variety of multiphase flow environments and for hydrocarbons with a variety of water cuts. The systems and methods of the present disclosure may allow for assessment and mitigation of corrosion in pipelines that carry hydrocarbon fluid with a water cut from 1% to 85% (or 0.1% to 99.9%, or 0% to 100%, or 1% to 50%, or 25% to 75%, or 50% to 85%).

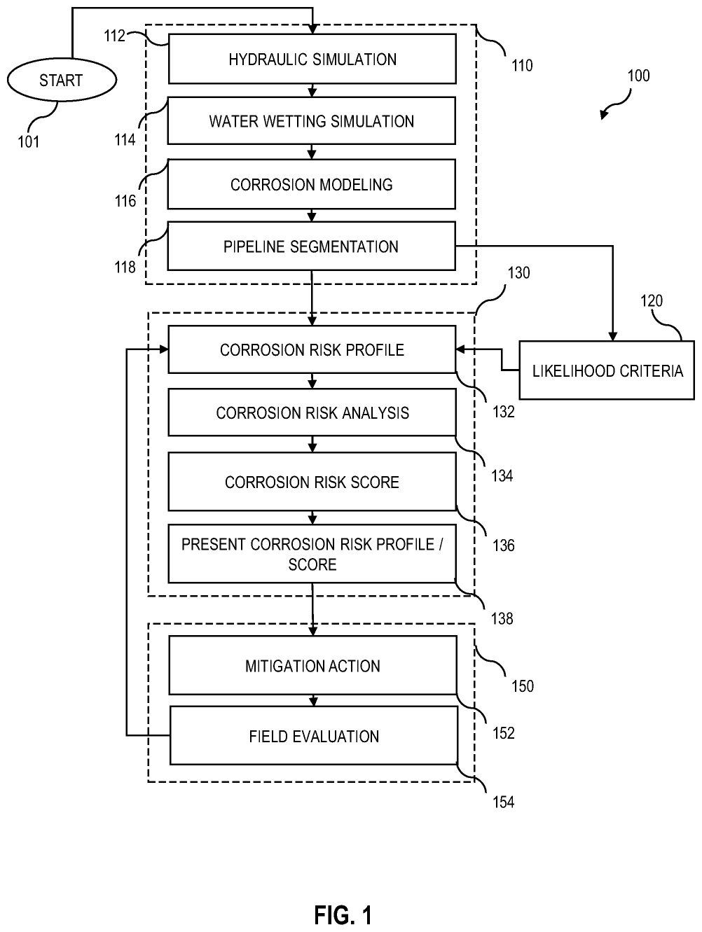

FIG. 1 shows a diagram of a method 100 for assessing and mitigating corrosion within a hydrocarbon pipeline according to the present disclosure. A start block 101 may initiate the method. Initial steps of the method may occur as part of the physical modeling sub-method 110. Within the physical modeling sub-method 110, hydraulic simulation 112, water wetting simulation 114, corrosion modeling 116, and pipeline segmentation 118 may occur in order to assess individual regions of the pipeline for physical and chemical properties that may influence corrosion risk. The physical modeling sub-method 110 may provide data from outputs of individual blocks within the sub-method to likelihood criteria 120 as well as to a corrosion risk analysis sub-method 130. The corrosion risk analysis sub-method 130 may utilize data outputted from the physical modeling sub-method 110 and from likelihood criteria 120 to assemble a corrosion risk profile 132. The data held within the corrosion risk profile 132 may be used to analyze the corrosion risk for a pipeline as part of corrosion risk analysis 134. Corrosion risk analysis 134 may output a corrosion risk score 136 that indicates the risk of corrosion for a pipe region or multiple pipe regions. The corrosion risk analysis sub-method 130 may further comprise presenting 138 the corrosion risk score and the corrosion risk profile to the user. Data from the corrosion risk profile 132 and corrosion risk score 136 may be used to generate and to perform a mitigation action 152 as part of mitigation sub-method 150. The mitigation sub-method 150 may include a field evaluation 154, which may be used to generate data that may be included in the corrosion risk profile 132 for further analysis.

It should be noted that the herein described methods and models may also be used in any combination as a part of a system that executes at least a portion of said methods and models according to the present disclosure.

### Pipeline Segmentation

In order to clarify the structure of the methods and systems of the present disclosure, a description of levels of segmentation is provided herein.

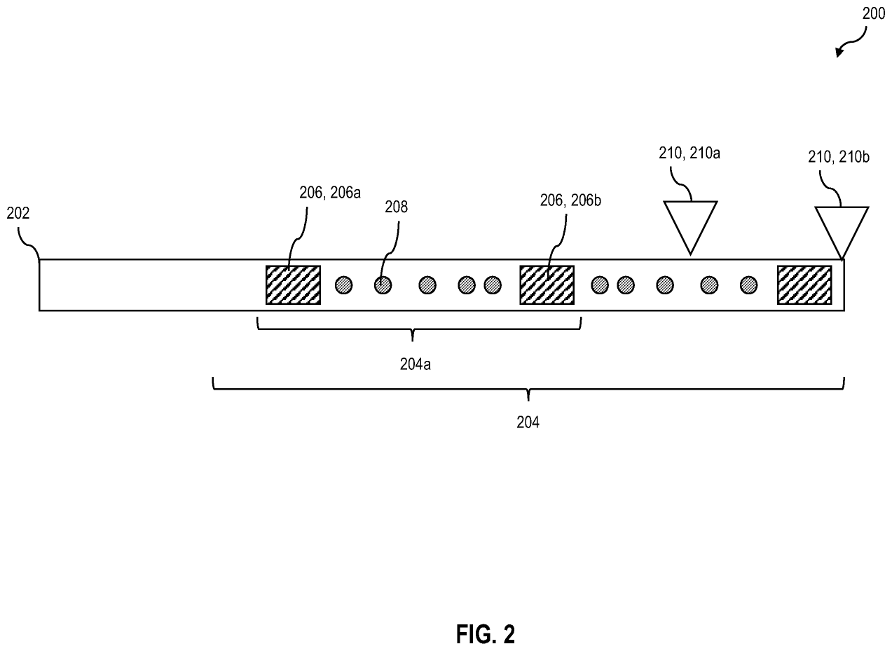

Within a pipeline there may be multiple levels of segmentation for which data may be provided, generated, or any combination thereof. FIG. 2 is provided as a nonlimiting example to assist in illustrating the hierarchy of segmentation for any pipeline of interest.

The illustrative pipeline system 200 may comprise a pipeline 202 that may have within it a pipe region 204 (or region). The pipe region 204 may be a region of interest of any size within any pipeline of the present disclosure and may comprise the whole of a pipeline 202. Within the pipe region 204 there may be one or more sub-regions 204a. Within the pipe region 204 there may be one or more sampling segments 206. Between two sampling segments 206a and 206b there may be one or more pipe nodes 208 (or nodes). It should be noted that while 5 nodes are displayed between 206a and 206b in FIG. 2, any number of nodes may exist between two sampling segments. The pipeline 202 may also have one or more points of interest 210 that may be of use in providing discrete data for a specific point along the pipeline 202. Examples of points of interest 210 may include, but are not limited to, a pipe outlet, a wellhead inlet, or any combination thereof. Points of interest 210 may exist within a pipe region 204 of a pipeline 202 (e.g., point of interest 210a) including at a node 208 and may exist at the end of a pipe region 204 or pipeline 202 (e.g., point of interest 210b). Note that some pipelines 202 or some pipe regions 204 may not have any points of interest 210.

Division of levels of hierarchy (e.g., sampling segments, pipe regions, nodes, and the like) may be determined by user input or may be determined dynamically by or based on models of the present disclosure including, but not limited to, a hydraulic model, a water wetting model, a nodal model, a corrosion model, or any combination thereof.

Additional levels of hierarchy (e.g., sub-sub-regions within sub-regions) may be used in accordance with the present disclosure. Additional branches, pumps, valves, and other similar features not shown herein may be present along the length of a pipeline in accordance with the present disclosure.

Data used in the corrosion risk assessment and mitigation systems and methods in accordance with the present disclosure may be provided for any suitable level of hierarchy within the pipeline system (e.g., for the pipeline as a whole, for a pipe region, for a sampling segment, for a node, for a point of interest, or any combination thereof). For example, pipe diameter may be provided for an entire pipeline. As another example, gas density and flow pattern may be provided, initially, for one or more sampling segments, and, subsequently, gas density and flow pattern may also be provided for one or more nodes between or near the one or more sampling segments.

### Physical Modeling Sub-Method

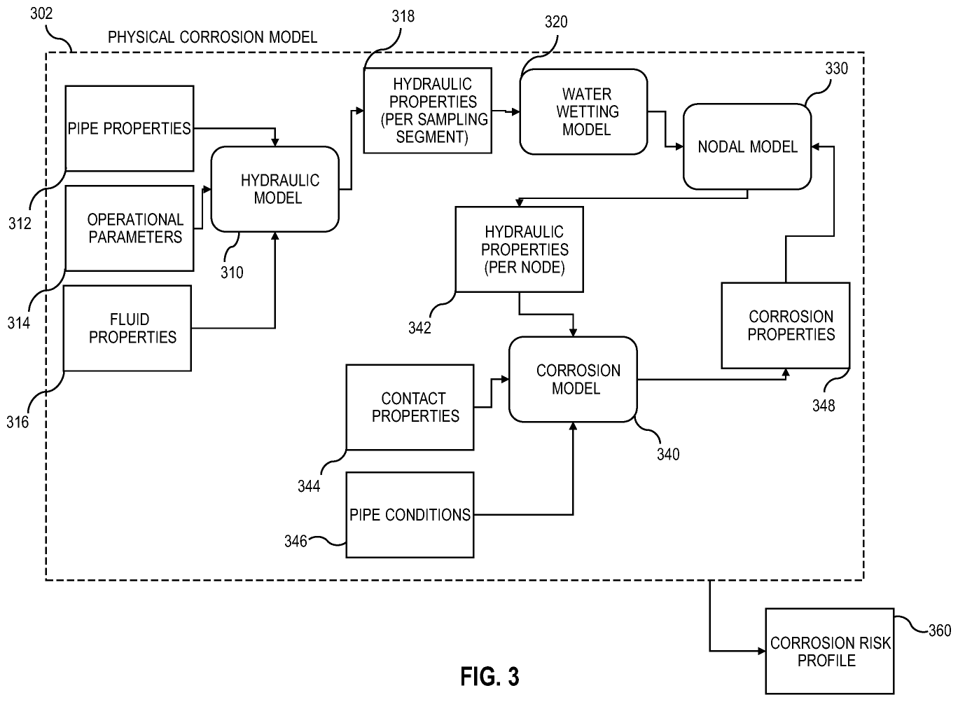

In accordance with the present disclosure, a physical modeling sub-method (equivalent to physical modeling sub-method 110 as depicted in FIG. 1) may be used to model conditions within a pipe region of a hydrocarbon pipeline using a physical corrosion model. A diagram of a physical corrosion model used as part of physical modeling sub-method is shown in FIG. 3.

The physical corrosion risk model 302 may comprise a hydraulic model 310, a water wetting model 320, a nodal model 330 (or a dynamic segmentation model), and a corrosion model 340. The physical corrosion risk model 302 may output data to a corrosion risk profile 360.

### Hydraulic Model

The hydraulic model 310 may receive hydraulic model inputs that may comprise one or more pipe properties 312, one or more operational parameters 314, one or more fluid properties 316, or any combination thereof. The hydraulic model 310 may dynamically perform an initial segmentation of the pipeline, including, but not limited to, into pipe regions or sampling segments within pipe regions. Initial segmentation may also be conducted by the user in combination with dynamic segmentation or in lieu of dynamic segmentation. Initial segmentation may be based on hydraulic model inputs.

The pipe properties 312 may comprise any pipe property for a pipe region or sampling segment within the pipe region, wherein the pipe property may be relevant for modeling hydraulic flow. The pipe properties 312 may include, but are not limited to, pipe diameter, pipe elevation, pipe geographic position (e.g., latitude and longitude), pipe interior roughness, pipe thickness, pipe thermal conductivity, the like, or any combination thereof. It should be noted that in the case of discrete properties such as pipe elevation or pipe geographic position, these properties may be provided for a point of interest, which may include an endpoint or midpoint of a pipe region, or any combination thereof.

The operational parameters 314 may comprise any operational properties of the fluid flowing within a pipe region or sampling segment within the pipe region, wherein the operational property may be relevant for modeling hydraulic flow including, but not limited to, sink pressure, liquid phase flowrate, temperature, water cut, gas to liquid ratio, the like, or any combination thereof. As sink pressure is a discrete property it may be localized to a point of interest, such as, for example, to an outlet of a pipe region. Temperature, another discrete property, may be localized to a point of interest, such as, for example, to a wellhead.

The fluid properties 316 may comprise any properties of the fluid within a pipe region or sampling segment within the pipe region, wherein the operational property may be relevant for modeling hydraulic flow including, but not limited to, specific gravity, API gravity, specific heat capacity, viscosity, specific latent heat of vaporization, composition (e.g., mole fraction, mass fraction, volume fraction, and the like), inversion water cut (e.g., emulsion inversion water cut), oil formation volume factor (OFVF), the like, or any combination thereof.

Specific gravity, specific heat capacity, viscosity, and specific latent heat of vaporization may each be for the fluid as a whole, for any constituent component (including oil, gas, water, or the like), or for the fluid as a whole and for any constituent component. Composition may include composition of only primary components within the fluid (e.g., oil, gas, water, or any combination thereof), of only contaminants within the fluid (e.g., CO₂, H₂S, N₂, H₂, CO, and the like), or of primary components and contaminants within the fluid.

The hydraulic model 310 may utilize hydraulic model inputs to simulate hydraulic flow within the pipe region including for a sampling segment within a pipe region. The hydraulic model 310 may operate by utilizing laws of chemistry and physics well known in the art to interrelate chemical and physical properties of the pipeline and of species within the pipeline, in order to output data that quantifies properties of and related to fluid flow within the pipeline.

The hydraulic model output may comprise one or more hydraulic properties (per sampling segment) 318, as calculated by the hydraulic model 310. The per sampling segment hydraulic properties 318 may be localized to a specific sampling segment within a pipeline of the present disclosure. The sampling segment hydraulic properties 318 may include, but are not limited to, in-situ velocity (for a liquid phase, a gas phase, or both), density (of oil, of gas, of water, or any combination thereof), viscosity (of oil, of gas, of water, or any combination thereof), oil-water flow pattern, gas-liquid flow pattern, pressure, the like, or any combination thereof.

### Water Wetting Simulation

The water wetting model 320 may simulate water wetting for a sampling segment within a pipe region. The water wetting model 320 may receive a water wetting model input, which may comprise the per sampling segment hydraulic properties 318. The water wetting model 320 may output a water wetting model output, which may comprise a wetting condition indicator, wherein the wetting condition indicator indicates the tendency of the fluid within the pipeline to water wet or to oil wet the surface of the pipeline or sampling segment therein. The water wetting model output may further comprise minimum oil wetting velocity, critical water cut, the like, or any combination thereof.

The nodal model 330 (or dynamic segmentation model) may receive a wetting condition indicator (indicating either oil wetting or water wetting) from the water wetting model 320. The nodal model 330 (or dynamic segmentation model) may receive corrosion properties 348 from a previous iteration from the corrosion model 340. The nodal model interpolates between sampling segments to produce one or more per node hydraulic properties 342. The nodal model may use interpolation methods known in the art including, but not limited to, linear interpolation, nearest-neighbor interpolation, spline interpolation, mimetic interpolation, polynomial interpolation, multivariate interpolation, the like, or any combination thereof. The nodal model may utilize a mass balance, a momentum balance, an energy balance, the like, or any combination thereof. The aforementioned balance may serve as an interpolation method or may supplement an interpolation method or methods in the nodal model. The nodal model output may comprise per node hydraulic properties. The per node hydraulic properties 342 may be localized to one or more nodes between two sampling segments of a pipeline of the present disclosure. The per node hydraulic properties 342 may include, but are not limited to, in-situ velocity (for a liquid phase, a gas phase, or both), density (of oil, of gas, of water, or any combination thereof), viscosity (of oil, of gas, of water, or any combination thereof), pressure, the like, or any combination thereof.

### Corrosion Modeling

The corrosion model 340 may simulate corrosion for a pipe region, a pipe node, a sampling segment, or any combination thereof. The corrosion model 340 may receive a corrosion model input, which may comprise the one or more per node hydraulic properties 342, one or more contact properties 344, one or more pipe conditions 346, or any combination thereof.

The contact properties 344 may include, but are not limited to, oil-water interfacial tension, gas-liquid interfacial tension, and contact angle (e.g., contact angle between oil and pipe wall or contact angle between water and pipe wall). The contact properties 344 may be localized to a pipe region, to a sampling segment, or to a node therebetween and may be based on field sampling and lab characterization.

The pipe conditions 346 may include, but are not limited to, pipe inclination angle, pipe alkalinity, wall shear stress, the like, or any combination thereof. The pipe conditions 346 may be localized to a pipe region, to a sampling segment, or to a node therebetween.

The corrosion model 340 may operate by utilizing laws of chemistry and physics well known in the art to interrelate chemical and physical properties the pipeline and of species within the pipeline, in order to output data that quantifies corrosion progression and related properties within the pipeline.

The corrosion model 340 may produce one or more corrosion model outputs based on simulating corrosion that may include corrosion properties 348. Corrosion properties 348 may include, but are not limited to, wetting regimes, CO₂ corrosion rate, H₂S corrosion rate, or any combination thereof. Corrosion properties 348 may be localized to a pipe region, to a sampling segment, or to a node therebetween.

The corrosion properties 348 may be received by the nodal model 330 for further iteration.

It should be noted that portions of or the whole of the physical corrosion risk model 302, including the hydraulic model 310, water wetting model 320, nodal model 330, and corrosion model 340, may be iterated one time or more than one time in order to, for example, increase precision of calculations or perform calculations for additional pipe regions or nodes. Data generated in one iteration may be used by any component of the physical corrosion risk model 302 in a subsequent iteration.

After a single or multiple iterations of the physical corrosion risk model 302, the physical corrosion risk model 302 subsequently outputs data to the corrosion risk profile 360. This data may include inputs, outputs, or inputs and outputs of any of the models including the hydraulic model 310, water wetting model 320, nodal model 330, and corrosion model 340.

### Corrosion Risk Sub-Method

Referring back to FIG. 1, following the physical modeling sub-method 110, the system may carry out a corrosion risk analysis sub-method 130, which may comprise the generation of a corrosion risk profile 132 and a corrosion risk analysis 134 that may produce a corrosion risk score 136. The sub-method may further comprise wherein the corrosion risk profile, the corrosion risk score, or both are presented 138 to the user.

### Corrosion Risk Profile

The corrosion risk profile (132 in FIGS. 1 and 360 in FIG. 3) comprises a set of data that may assist in calculating the actual risk of corrosion. The corrosion risk profile 132, 360 may comprise physical modeling data (including data from the hydraulic model 310, the water wetting model 320, the nodal model 330, the corrosion model 340, or any combination thereof), likelihood criteria 120, or any combination thereof.

Likelihood criteria 120 comprise any data that may support calculation of corrosion risk. Likelihood criteria 120 may be based on any suitable source including calculation, field analysis, lab experimentation, the like, or any combination thereof.

Likelihood criteria 120 may comprise historical data for the pipe region, or one or more points of interest within the pipe region and may include production history, leak history, or any combination thereof.

Production history may comprise current operational data, past operational data, or a combination thereof for a pipeline or pipe region as well as the fluid flowing therein and may include, but is not limited to, operational uptime, flowrate (e.g., mass flowrate, volume flowrate), fluid types (e.g., fluid composition, including water cut), fluid velocity, fluid corrosivity, microbial load, corrosion inhibitor use (including corrosion inhibitor composition, corrosion inhibitor quantity, the like or any combination thereof), the like, or any combination thereof. Production history data may be provided in discrete form (for one or more specific individual hours, days, months, years, or longer) or may be provided in summary form (e.g., 3100 hours of 94.9% methane flow with 3.2% water content). Production history data may inform the extent to which a pipeline has been operated intermittently, which, without being bound by theory, may increase the likelihood of corrosion occurring.

Leak history may comprise data on specific leaks throughout the history of a pipeline and may be localized to a point of interest where the leak occurred or continues to occur or may be localized to a pipe region. Leak history may include, but is not limited to, leak physical geometry (e.g., 1 cm diameter leak), leak flow size (e.g., 5 barrel per day leak), leak location (including approximate localization to a pipe region or precise localization to a point of interest where the leak occurred).

Likelihood criteria 120 may further comprise pipe coating composition, pipe coating application history (e.g., when a pipe coating was applied), and pipe coating location(s). Likelihood criteria 120 may further comprise one or more scraping compliance metrics (e.g., scraping frequency, scraping history, scraping type, and the like).

### Corrosion Risk Analysis and Score Generation

The corrosion risk profile 132, 360 is utilized to conduct a corrosion risk analysis 134 for a pipe region. The corrosion risk analysis 134 statistically analyzes one or more factors (based on data from the corrosion risk profile 132, 360), which may predict the risk of corrosion by comparing the one or more factors to known indicators of corrosion or lack thereof.

The corrosion risk analysis 134 may output a corrosion risk score 136. The corrosion risk score 136 may comprise a numerical score for a pipe region (or sampling segment, or pipe node), which quantifies the level of corrosion risk. The corrosion risk score 136 may comprise an integer on a scale (e.g., 0 to 10 or 1 to 100) wherein one numerical end of the scale indicates higher corrosion risk (e.g., a higher probability of failure or degraded operation due to corrosion) and the other end of the scale indicates lower corrosion risk (e.g., a lower probability of failure or degraded operation due to corrosion).

### Presentation of Corrosion Data

The corrosion risk profile, the corrosion risk score, or both may be presented 138 to the user. Presenting 138 the corrosion risk profile, the corrosion risk score, or both may comprise presenting in a graphical user interface (GUI). The GUI may comprise a geographic map in which representations of one or more pipelines and constituent pipe regions are displayed in such a manner that the one or more pipelines are localized to one or more locations on the geographic map. A color code may overlay the representations of the one or more pipe regions and the color code may correspond to the corrosion risk score for that pipe region. The color code may be such that a certain color or colors correspond to the corrosion risk score based on threshold value(s), which may be adjusted by the user within the graphical user interface or may be preset by the system. The GUI may allow the user to zoom in and to zoom out in order to view the representations of the pipeline or pipe region in greater detail. The GUI may also allow the user to view data from the corrosion risk profile that is localized to the representation of the pipeline or pipe region as displayed. The GUI may also allow the user to view additional non-localized data of the corrosion risk profile including the whole corrosion risk profile. The GUI may also display a representation of a point of interest. The GUI may also display a representation of a pipe node. The GUI may also display additional data from the corrosion risk profile localized to the representation of the point of interest, the representation of the pipe node, or to a combination thereof.

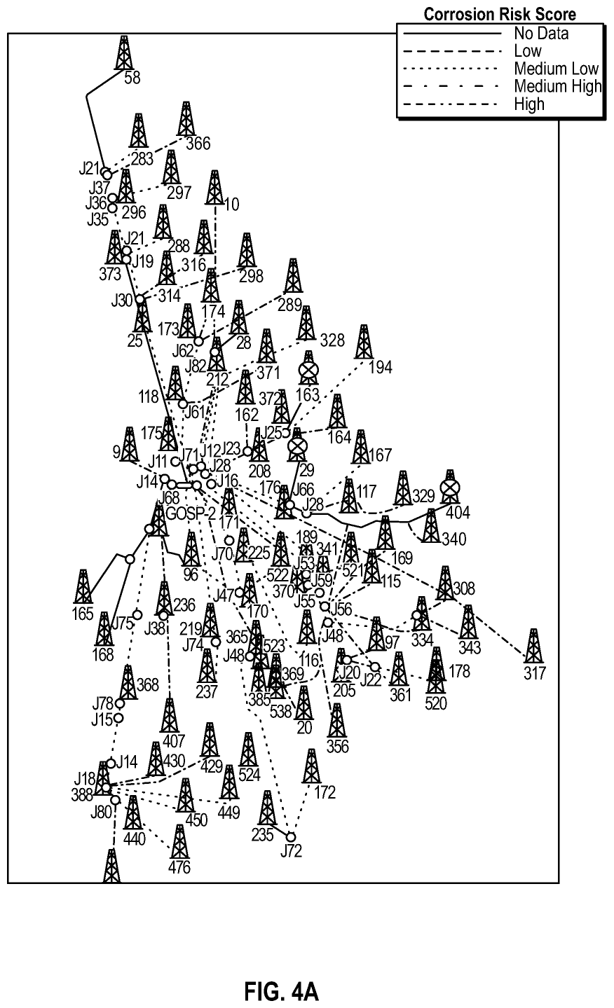

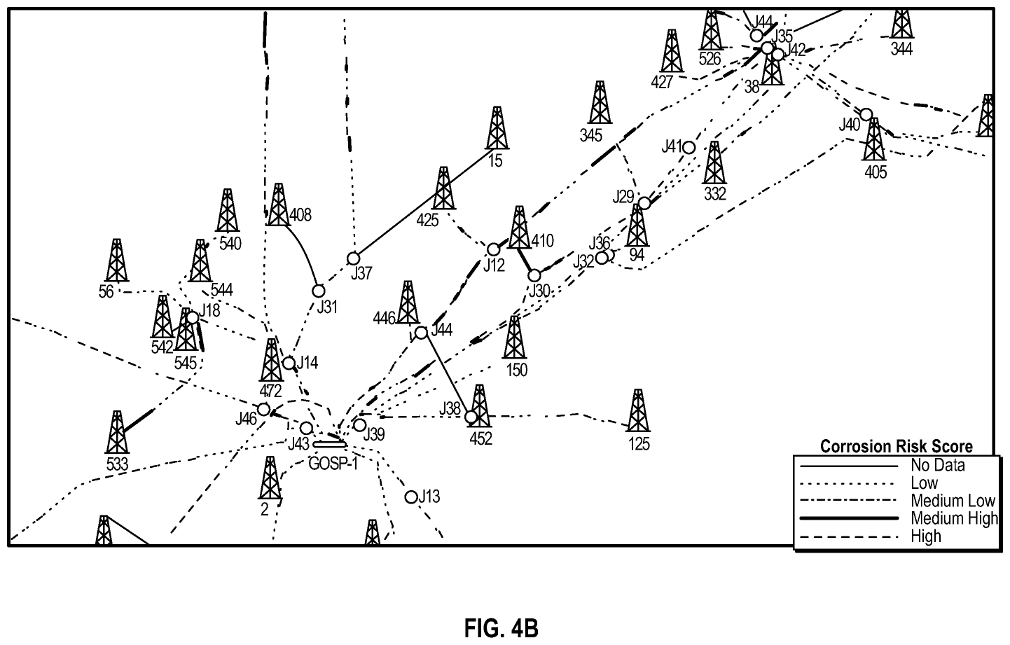

As a nonlimiting example, FIGS. 4A and 4B each show a GUI that displays representations of one or more pipelines and constituent pipe regions on a geographic map. FIGS. 4A and 4B show the corrosion risk score overlaid as a color code on the geographic map.

The GUI may enable a user to visually identify one or more corrosion risk clusters. A corrosion risk cluster may comprise wherein more than one pipe region located in proximity to another may have a corrosion risk score that indicates a higher probability of corrosion. Identification of corrosion risk clusters may be of particular importance to prioritizing various pipe regions for corrosion mitigation.

### Mitigation Action

The methods and systems of the present disclosure may further comprise performing one or more mitigation actions for a pipe region based on the corrosion risk profile, the corrosion risk score, or both. The one or more mitigation actions may include, but are not limited to, conducting a field evaluation, repairing or rehabilitating the pipe region, replacing the pipe region, generating a corrosion mitigation plan for the pipe region, the like, or any combination thereof.

Field evaluation may comprise pipeline health monitoring through any suitable means known in the art including, but not limited to, online sampling, materials testing, visual inspection, or any combination thereof.

The one or more mitigation actions may be carried out for a pipeline or pipe region. A single mitigation action for a pipeline or pipe region may be applied to one or more pipelines or one or more pipe regions (e.g., a mitigation in a singular area of a pipe region may serve as mitigation for an entire pipeline).

It should be noted that the one or more mitigation actions may be performed by a person, a machine, or any combination thereof.

### Computer System

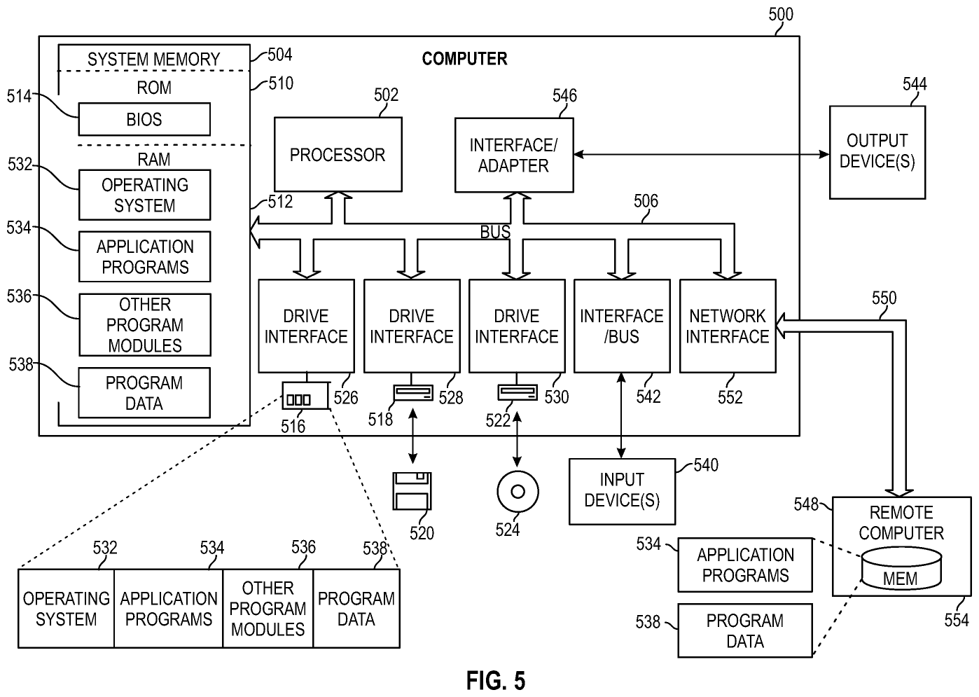

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-usable storage medium having computer-readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions that implement the function specified. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

In this regard, FIG. 5 illustrates one example of a computer system 500 that can be employed to execute one or more embodiments of the present disclosure. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 502, system memory 504, and system bus 506 that couples various system components, including the system memory 504, to processing unit 502. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 510 and random access memory (RAM) 512. A basic input/output system (BIOS) 514 can reside in ROM 510 containing the basic routines that help to transfer information among elements within computer system 500.

Computer system 500 can include a hard disk drive 516, magnetic disk drive 518, e.g., to read from or write to removable disk 520, and an optical disk drive 522, e.g., for reading CD-ROM disk 524 or to read from or write to other optical media. Hard disk drive 516, magnetic disk drive 518, and optical disk drive 522 are connected to system bus 506 by a hard disk drive interface 526, a magnetic disk drive interface 528, and an optical drive interface 530, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 512, including operating system 532, one or more application programs 534, other program modules 536, and program data 538. In some examples, the application programs 534 can include the physical modeling sub-method 110, the hydraulic model 310, the water wetting model 320, the nodal model 330, the corrosion model 340, the corrosion risk analysis sub-method 130, the mitigation sub-method 150, and the program data 538 can include pipe properties 312, operational parameters 314, fluid properties 316, per sampling segment hydraulic properties 318, per node hydraulic properties 342, contact properties 344, pipe conditions 346, corrosion properties 348, likelihood criteria 120, corrosion risk profile 132 or 360, corrosion risk score 136, and mitigation action 152. The application programs 534 and program data 538 can include functions and methods programmed to evaluate, quantify, or mitigate (or any combination thereof) the corrosion risk of a pipeline or pipe region within a pipeline, such as shown and described herein.

A user may enter commands and information into computer system 500 through one or more input devices 540, such as a pointing device (e.g., a mouse, touch screen), keyboard, microphone, joystick, game pad, scanner, and the like. For instance, the user can employ input device 540 to edit or modify pipe properties 312, operational parameters 314, fluid properties 316, per sampling segment hydraulic properties 318, per node hydraulic properties 342, contact properties 344, pipe conditions 346, corrosion properties 348, likelihood criteria 120, or any combination thereof. As another example, the user may also employ input device 540 to view data from the corrosion risk profile 132 (or 360), the corrosion risk score 136, or any combination thereof. These and other input devices 540 are often connected to processing unit 502 through a corresponding port interface 542 that is coupled to the system bus, but may be connected by other interfaces, such as a parallel port, serial port, or universal serial bus (USB). One or more output devices 544 (e.g., display, a monitor, printer, projector, or other type of displaying device) are also connected to system bus 506 via interface 546, such as a video adapter.

Computer system 500 may operate in a networked environment using logical connections to one or more remote computers, such as remote computer 548. Remote computer 548 may be a workstation, computer system, router, peer device, or other common network node, and typically includes many or all of the elements described relative to computer system 500. The logical connections, schematically indicated at 550, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 500 can be connected to the local network through a network interface or adapter 552. When used in a WAN networking environment, computer system 500 can include a modem, or can be connected to a communications server on the LAN. The modem, which may be internal or external, can be connected to system bus 506 via an appropriate port interface. In a networked environment, application programs 534 or program data 538 depicted relative to computer system 500, or portions thereof, may be stored in a remote memory storage device 554.

### Additional Embodiments

Embodiment 1. A method comprising: generating a corrosion risk profile for a first pipe region of at least one pipe region of a hydrocarbon pipeline configured to carry a hydrocarbon fluid, wherein generating the corrosion risk profile comprises: simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property; simulating water wetting within the first sampling segment using a water wetting model, wherein a water wetting model input comprises the per sampling segment hydraulic property from the hydraulic model, and wherein a water wetting model output comprises a wetting condition indicator; interpolating between the first sampling segment and a second sampling segment using a nodal model, wherein a nodal model input comprises the wetting condition indicator from the water wetting model, and wherein a nodal model output comprises a per node hydraulic property; simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and generating the corrosion risk profile for the first pipe region based on a corrosion likelihood criteria, the corrosion properties, the per sampling segment hydraulic property, and the per node hydraulic property; analyzing the corrosion risk profile in order to calculate a corrosion risk score for the first pipe region.

Embodiment 2. The method of Embodiment 1, further comprising: performing at least one mitigation action for the first pipe region based on the corrosion risk score, the corrosion risk profile, or any combination thereof.

Embodiment 3. The method of Embodiment 2, wherein performing the at least one mitigation action for the first pipe region comprises: conducting a field evaluation of the first pipe region, rehabilitating the first pipe region, replacing at least a portion of the first pipe region, generating a corrosion mitigation plan for the first pipe region, or any combination thereof.

Embodiment 4. The method of any one of Embodiments 1-3, further comprising displaying the corrosion risk score, and optionally the corrosion risk profile, in a graphical user interface, wherein the graphical user interface comprises a geographic map that comprises a representation of the first pipe region localized to one or more locations on the geographic map, and wherein the corrosion risk score is displayed as a color code overlaid on the representation of the first pipe region.

Embodiment 5. The method of Embodiment 4, further comprising identifying a corrosion risk cluster using the graphical user interface.

Embodiment 6. The method of any one of Embodiments 1-5, wherein the per sampling segment hydraulic property comprises: a liquid phase in-situ velocity, a gas phase in-situ velocity, an oil density, a gas density, a water density, an oil viscosity, a gas viscosity, a water viscosity, an oil-water flow pattern, a gas-liquid flow pattern, a pressure, or any combination thereof.

Embodiment 7. The method of any one of Embodiments 1-6, wherein the per node hydraulic property comprises: a liquid phase in-situ velocity, a gas phase in-situ velocity, an oil density, a gas density, a water density, an oil viscosity, a gas viscosity, a water viscosity, a pressure, or any combination thereof.

Embodiment 8. The method of Embodiments 1-7, wherein the corrosion likelihood criteria comprises: a production history, a leak history, a pipe coating composition, a pipe coating application history, a pipe coating location, a scraping compliance metric, or any combination thereof.

Embodiment 9. The method of Embodiment 8, wherein the production history comprises: an operational uptime, a flowrate, a fluid composition, a fluid velocity, a fluid corrosivity, a microbial load, a corrosion inhibitor composition, a corrosion inhibitor quantity, or any combination thereof.

Embodiment 10. The method of any one of Embodiments 1-9, wherein the operational property comprises: a pipe diameter, a pipe elevation, a pipe geographic position, a pipe interior roughness, a pipe thickness, a pipe thermal conductivity, or any combination thereof.

Embodiment 11. The method of any one of Embodiments 1-10, wherein the operational property comprises: a sink pressure, a liquid phase flowrate, a temperature, a water cut, a gas to liquid ratio.

Embodiment 12. The method of any one of Embodiments 1-11, wherein the fluid property comprises: a specific gravity, API gravity, a specific heat capacity, a viscosity, a specific latent heat of vaporization, a composition, an emulsion inversion water cut, an oil formation volume factor, or any combination thereof.

Embodiment 13. The method of any one of Embodiments 1-12, wherein a water cut of the hydrocarbon fluid is from 0.1% to 85%.

Embodiment 14. The method of any one of Embodiments 1-13, wherein the contact property comprises: an oil-water interfacial tension, a gas-liquid interfacial tension, a contact angle between oil and pipe wall, a contact angle between water and pipe wall, or any combination thereof.

Embodiment 15. The method of any one of Embodiments 1-14, wherein the pipe condition comprises: a pipe inclination angle, a pipe alkalinity, a wall shear stress, or any combination thereof.

Embodiment 16. The method of any one of Embodiments 1-15, wherein the hydrocarbon pipeline comprises a non-scrapable pipeline.

Embodiment 17. The method of any one of Embodiments 1-16, wherein the hydrocarbon pipeline comprises a dry gas pipeline, a wet gas pipeline, a liquid petroleum pipeline, or a multiphase pipeline.

Embodiment 18. The method of any one of Embodiments 1-17, wherein calculating the corrosion risk score comprises performing a statistical analysis using the corrosion risk profile.

Embodiment 19. A machine-readable storage medium having stored thereon a computer program for performing the steps of: generating a corrosion risk profile for a first pipe region of at least one pipe region of a hydrocarbon pipeline configured to carry a hydrocarbon fluid, wherein generating the corrosion risk profile comprises: simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property; simulating water wetting within the first sampling segment using a water wetting model, wherein a water wetting model input comprises the per sampling segment hydraulic property from the hydraulic model, and wherein a water wetting model output comprises a wetting condition indicator; interpolating between the first sampling segment and a second sampling segment using a nodal model, wherein a nodal model input comprises the wetting condition indicator from the water wetting model, and wherein a nodal model output comprises a per node hydraulic property; simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and generating the corrosion risk profile for the first pipe region based on a corrosion likelihood criteria, the corrosion properties, the per sampling segment hydraulic property, and the per node hydraulic property; analyzing the corrosion risk profile in order to calculate a corrosion risk score for the first pipe region.

Embodiment 20. The machine-readable storage medium of Embodiment 19, wherein the method further comprises: causing a person, a machine, or any combination thereof to take at least one mitigation action for the first pipe region, wherein the at least one mitigation is based on the corrosion risk score, the corrosion risk profile, or any combination thereof.

Embodiment 21. The machine-readable storage medium of Embodiment 20, wherein the at least one mitigation action comprises: a field evaluation of the first pipe region, a rehabilitation of the first pipe region, a replacement of at least a portion of the first pipe region, a corrosion mitigation plan for the first pipe region, or any combination thereof.

Embodiment 22. The machine-readable storage medium of any one of Embodiments 19-21, wherein the method further comprises: displaying or causing to be displayed in a graphical user interface the corrosion risk score, and optionally the corrosion risk profile, wherein the graphical user interface comprises a geographic map that comprises a representation of the first pipe region localized to one or more locations on the geographic map, and wherein the corrosion risk score is displayed as a color code overlaid on the representation of the first pipe region.

Embodiment 23. The machine-readable storage medium of Embodiment 22, further comprising a corrosion risk cluster identified using the graphical user interface.

Embodiment 24. The machine-readable storage medium of any one of Embodiments 19-23, wherein the per sampling segment hydraulic property comprises: a liquid phase in-situ velocity, a gas phase in-situ velocity, an oil density, a gas density, a water density, an oil viscosity, a gas viscosity, a water viscosity, an oil-water flow pattern, a gas-liquid flow pattern, a pressure, or any combination thereof.

Embodiment 25. The machine-readable storage medium of any one of Embodiments 19-24, wherein the per node hydraulic property comprises: a liquid phase in-situ velocity, a gas phase in-situ velocity, an oil density, a gas density, a water density, an oil viscosity, a gas viscosity, a water viscosity, a pressure, or any combination thereof.

Embodiment 26. The machine-readable storage medium of any one of Embodiments 19-25, wherein the corrosion likelihood criteria comprises: a production history, a leak history, a pipe coating composition, a pipe coating application history, a pipe coating location, a scraping compliance metric, or any combination thereof.

Embodiment 27. The machine-readable storage medium of Embodiment 26, wherein the production history comprises: an operational uptime, a flowrate, a fluid composition, a fluid velocity, a fluid corrosivity, a microbial load, a corrosion inhibitor composition, a corrosion inhibitor quantity, or any combination thereof.

Embodiment 28. The machine-readable storage medium of any one of Embodiments 19-27, wherein the operational property comprises: a pipe diameter, a pipe elevation, a pipe geographic position, a pipe interior roughness, a pipe thickness, a pipe thermal conductivity, or any combination thereof.

Embodiment 29. The machine-readable storage medium of any one of Embodiments 19-28, wherein the operational property comprises: a sink pressure, a liquid phase flowrate, a temperature, a water cut, a gas to liquid ratio.

Embodiment 30. The machine-readable storage medium of any one of Embodiments 19-29, wherein the fluid property comprises: a specific gravity, API gravity, a specific heat capacity, a viscosity, a specific latent heat of vaporization, a composition, an emulsion inversion water cut, an oil formation volume factor, or any combination thereof.

Embodiment 31. The machine-readable storage medium of any one of Embodiments 19-30, wherein a water cut of the hydrocarbon fluid is from 0.1% to 85%.

Embodiment 32. The machine-readable storage medium of any one of Embodiments 19-31, wherein the contact property comprises: an oil-water interfacial tension, a gas-liquid interfacial tension, a contact angle between oil and pipe wall, a contact angle between water and pipe wall, or any combination thereof.

Embodiment 33. The machine-readable storage medium of any one of Embodiments 19-32, wherein the pipe condition comprises: a pipe inclination angle, a pipe alkalinity, a wall shear stress, or any combination thereof.

Embodiment 34. The machine-readable storage medium of any one of Embodiments 19-33, wherein the hydrocarbon pipeline comprises a non-scrapable pipeline.

Embodiment 35. The machine-readable storage medium of any one of Embodiments 19-34, wherein the hydrocarbon pipeline comprises a dry gas pipeline, a wet gas pipeline, a liquid petroleum pipeline, or a multiphase pipeline.

Embodiment 36. The machine-readable storage medium of any one of Embodiments 19-35, wherein calculating the corrosion risk score comprises performing a statistical analysis using the corrosion risk profile.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes.” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, and so on) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
generating a corrosion risk profile for a first pipe region of at least one pipe region of a hydrocarbon pipeline configured to carry a hydrocarbon fluid, wherein generating the corrosion risk profile comprises:
simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property;
simulating water wetting within the first sampling segment using a water wetting model, wherein a water wetting model input comprises the per sampling segment hydraulic property from the hydraulic model, and wherein a water wetting model output comprises a wetting condition indicator;
interpolating between the first sampling segment and a second sampling segment using a nodal model, wherein a nodal model input comprises the wetting condition indicator from the water wetting model, and wherein a nodal model output comprises a per node hydraulic property;
simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and
generating the corrosion risk profile for the first pipe region based on a corrosion likelihood criteria, the corrosion properties, the per sampling segment hydraulic property, and the per node hydraulic property; and
analyzing the corrosion risk profile in order to calculate a corrosion risk score for the first pipe region.

2. The method of claim 1, further comprising:
performing at least one mitigation action for the first pipe region based on the corrosion risk score, the corrosion risk profile, or any combination thereof.

3. The method of claim 2, wherein performing the at least one mitigation action for the first pipe region comprises: conducting a field evaluation of the first pipe region, rehabilitating the first pipe region, replacing at least a portion of the first pipe region, generating a corrosion mitigation plan for the first pipe region, or any combination thereof.

4. The method of claim 1, further comprising displaying the corrosion risk score, and optionally the corrosion risk profile, in a graphical user interface, wherein the graphical user interface comprises a geographic map that comprises a representation of the first pipe region localized to one or more locations on the geographic map, and wherein the corrosion risk score is displayed as a color code overlaid on the representation of the first pipe region.

5. The method of claim 4, further comprising identifying a corrosion risk cluster using the graphical user interface.

6. The method of claim 1, wherein the per sampling segment hydraulic property comprises: a liquid phase in-situ velocity, a gas phase in-situ velocity, an oil density, a gas density, a water density, an oil viscosity, a gas viscosity, a water viscosity, an oil-water flow pattern, a gas-liquid flow pattern, a pressure, or any combination thereof.

7. The method of claim 1, wherein the corrosion likelihood criteria comprises: a production history, a leak history, a pipe coating composition, a pipe coating application history, a pipe coating location, a scraping compliance metric, or any combination thereof.

8. The method of claim 1, wherein a water cut of the hydrocarbon fluid is from 0.1% to 85%.

9. The method of claim 1, wherein the hydrocarbon pipeline comprises a non-scrapable pipeline.

10. The method of claim 1, wherein the hydrocarbon pipeline comprises a dry gas pipeline, a wet gas pipeline, a liquid petroleum pipeline, or a multiphase pipeline.

11. The method of claim 1, wherein calculating the corrosion risk score comprises performing a statistical analysis using the corrosion risk profile.

12. A machine-readable storage medium having stored thereon a computer program for performing the steps of:
generating a corrosion risk profile for a first pipe region of at least one pipe region of a hydrocarbon pipeline configured to carry a hydrocarbon fluid, wherein generating the corrosion risk profile comprises:
simulating hydraulic flow within a first sampling segment within the first pipe region using a hydraulic model, wherein a hydraulic model input comprises a pipe property, an operational property, a fluid property, or any combination thereof, and wherein a hydraulic model output comprises a per sampling segment hydraulic property;
simulating water wetting within the first sampling segment using a water wetting model, wherein a water wetting model input comprises the per sampling segment hydraulic property from the hydraulic model, and wherein a water wetting model output comprises a wetting condition indicator;
interpolating between the first sampling segment and a second sampling segment using a nodal model, wherein a nodal model input comprises the wetting condition indicator from the water wetting model, and wherein a nodal model output comprises a per node hydraulic property;
simulating corrosion for at least one first node between the first sampling segment and the second sampling segment using a corrosion model, wherein a corrosion model input comprises the per node hydraulic property, wherein the corrosion model input comprises a contact property, a pipe condition, or any combination thereof, and wherein a corrosion model output comprises a corrosion property; and
generating the corrosion risk profile for the first pipe region based on a corrosion likelihood criteria, the corrosion properties, the per sampling segment hydraulic property, and the per node hydraulic property;
analyzing the corrosion risk profile in order to calculate a corrosion risk score for the first pipe region.

13. The machine-readable storage medium of claim 12, wherein the method further comprises: causing a person, a machine, or any combination thereof to take at least one mitigation action for the first pipe region, wherein the at least one mitigation is based on the corrosion risk score, the corrosion risk profile, or any combination thereof.

14. The machine-readable storage medium of claim 13, wherein the at least one mitigation action comprises: a field evaluation of the first pipe region, a rehabilitation of the first pipe region, a replacement of at least a portion of the first pipe region, a corrosion mitigation plan for the first pipe region, or any combination thereof.

15. The machine-readable storage medium of claim 12, wherein the method further comprises: displaying or causing to be displayed in a graphical user interface the corrosion risk score, and optionally the corrosion risk profile, wherein the graphical user interface comprises a geographic map that comprises a representation of the first pipe region localized to one or more locations on the geographic map, and wherein the corrosion risk score is displayed as a color code overlaid on the representation of the first pipe region.

16. The machine-readable storage medium of claim 15, further comprising a corrosion risk cluster identified using the graphical user interface.

17. The machine-readable storage medium of claim 12, wherein a water cut of the hydrocarbon fluid is from 0.1% to 85%.

18. The machine-readable storage medium of claim 12, wherein the hydrocarbon pipeline comprises a non-scrapable pipeline.

19. The machine-readable storage medium of claim 12, wherein the hydrocarbon pipeline comprises a dry gas pipeline, a wet gas pipeline, a liquid petroleum pipeline, or a multiphase pipeline.

20. The machine-readable storage medium of claim 12, wherein calculating the corrosion risk score comprises performing a statistical analysis using the corrosion risk profile.
